(19) United States
(12) Patent Application Publication
(10) Pub. No.: US 2024/0234022 A9
(43) Pub. Date: Jul. 11, 2024

(54) INDUCTOR COMPONENT

(71) Applicant: Murata Manufacturing Co., Ltd., Kyoto-fu (JP)

(72) Inventors: Rikiya SANO, Nagaokakyo-shi (JP); Isamu MIYAKE, Nagaokakyo-shi (JP); Kenta KONDO, Nagaokakyo-shi (JP)

(73) Assignee: Murata Manufacturing Co., Ltd., Kyoto-fu (JP)

(21) Appl. No.: 18/488,585

(22) Filed: Oct. 17, 2023

(30) Foreign Application Priority Data
Oct. 20, 2022 (JP) 2022-168462

(51) Int. Cl. H01F 27/32; H01F 27/28

(52) U.S. Cl. CPC H01F 27/323; H01F 27/2828

(57) ABSTRACT

An inductor component includes an element body and an inductor wiring. The element body has a planar first main surface. The inductor wiring extends inside the element body. The inductor wiring includes a plurality of wiring portions arrayed in a direction perpendicular to the first main surface. The element body includes a plurality of interlayer insulating layers filling spaces between the wiring portions that are adjacent to each other in a direction perpendicular to the first main surface. The interlayer insulating layers each contain an insulating base material and a plurality of filler particles dispersed within the base material. In a first interlayer insulating layer, which is one of the plurality of interlayer insulating layers, the average particle size of the filler particles is less than or equal to the standard deviation of the thickness of the first interlayer insulating layer.

### CROSS-REFERENCE TO RELATED APPLICATION

This application claims benefit of priority to Japanese Patent Application No. 2022-168462, filed Oct. 20, 2022, the entire content of which is incorporated herein by reference.

### BACKGROUND

### Technical Field

The present disclosure relates to an inductor component.

### Background Art

An inductor component disclosed in Japanese Patent No. 6519561 includes an element body and an inductor wiring. The element body has a rectangular parallelepiped shape having six outer surfaces. The inductor wiring extends inside the element body. The inductor wiring includes a plurality of wiring portions. When one of the outer surfaces of the element body is regarding as a main surface, each wiring portion extends parallel to the main surface. The plurality of wiring portions are arrayed in a direction perpendicular to the main surface. Wiring portions that are adjacent to each other in the direction perpendicular to the main surface are connected to each other by vias. The element body further includes interlayer insulating layers. The interlayer insulating layers fill the spaces between the wiring portions in the direction perpendicular to the main surface.

### SUMMARY

In an inductor component such as that described in Japanese Patent No. 6519561, the thickness of the interlayer insulating layers vary due to manufacturing errors and so forth. The inventors found that large variations in the thickness of the interlayer insulating layers causes a large loss when a current flows through the inductor wiring. The element body may include an insulating base material and a plurality of filler particles dispersed in the base material. In this case, if the average particle size of the filler particles is excessively large, the variations between the interlayer insulating layers are likely to be larger.

Accordingly, an embodiment of the present disclosure provides an inductor component. The inductor component includes an element body having a planar main surface among outer surfaces thereof, and an inductor wiring that extends inside the element body. The inductor wiring includes a plurality of wiring portions arrayed in a first direction perpendicular to the main surface and a via connecting the wiring portions that are adjacent to each other in the first direction. The element body includes a plurality of interlayer insulating layers that fill spaces between the wiring portions that are adjacent to each other in the first direction. The interlayer insulating layers each contain an insulating base material and a plurality of filler particles dispersed within the base material. In a first interlayer insulating layer, which is one of the plurality of interlayer insulating layers, an average particle size of the filler particles is less than or equal to a standard deviation of a thickness of the first interlayer insulating layer.

With the above configuration, the average particle size of the filler particles is small relative to the standard deviation of the thickness of the first interlayer insulating layer. Therefore, the size of the average particle size of the filler particles is unlikely to have a significant effect on the standard deviation of the thickness of the first interlayer insulating layer. Therefore, variations in the thickness of the first interlayer insulating layer can be prevented from becoming large due to the average particle size of the filler particles.

It is possible to prevent variations in the thickness of the interlayer insulating layers from becoming large due to the average particle size of the filler particles.

### BRIEF DESCRIPTION OF THE DRAWINGS

FIG. 1 is a perspective view of an inductor component of an embodiment;

FIG. 2 is an exploded perspective view of the inductor component of the embodiment;

FIG. 3 is a see-through plan view of the inductor component of the embodiment;

FIG. 4 is a sectional view taken along line 4-4 in FIG. 3;

FIG. 5 is an enlarged sectional view of a wiring portion in FIG. 4; and

FIG. 6 is a sectional view taken along line 6-6 in FIG. 3.

### DETAILED DESCRIPTION

### Embodiment

Hereafter, an inductor component according to an embodiment will be described.

In the drawings, constituent elements may be illustrated in an enlarged manner for ease of understanding. The dimensional ratios of the constituent elements may differ from the actual ratios or may differ from the ratios in other drawings. Furthermore, hatching is used in the sectional views, but the hatching of some constituent elements may be omitted for ease of understanding.

### Overall Configuration

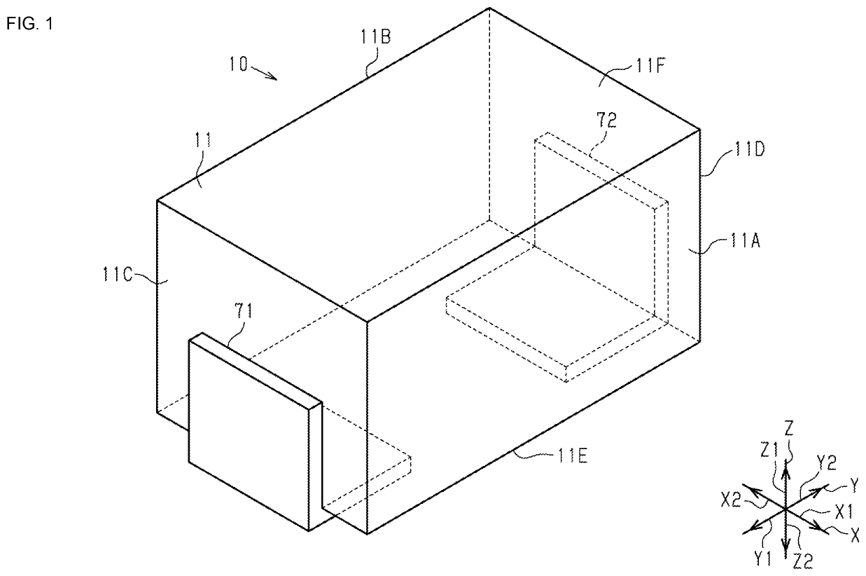

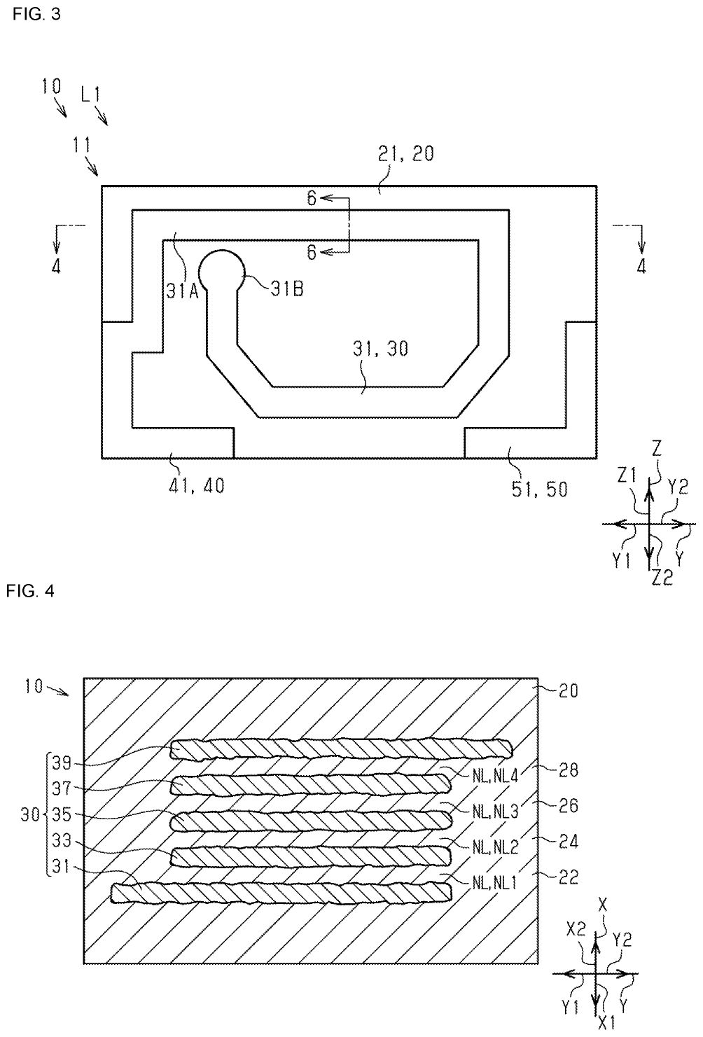

As illustrated in FIG. 1, an inductor component 10 includes a rectangular parallelepiped shaped element body 11. In addition, as illustrated in FIG. 3, the inductor component 10 includes an inductor wiring 30 that extends inside the element body 11, a first electrode 40 that is connected to a first end of the inductor wiring 30, and a second electrode 50 that is connected to a second end of the inductor wiring 30.

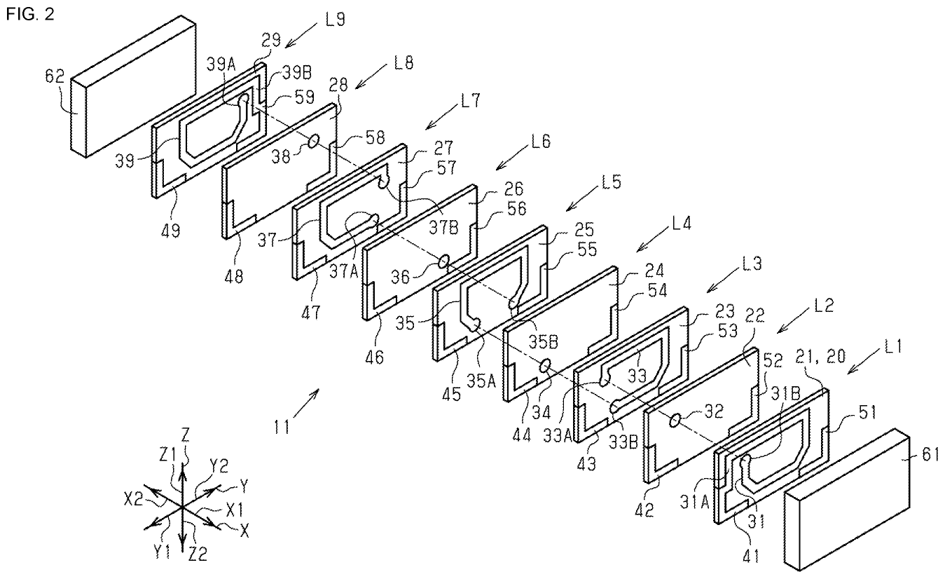

As illustrated in FIG. 2, the element body 11 has an overall structure in which a plurality of plate-like layers are stacked on top of one another. In addition, each layer has a rectangular shape in plan view. Since the element body 11 has a rectangular parallelepiped shape, the element body 11 has six planar outer surfaces. As illustrated in FIG. 1, out of these six outer surfaces, one particular surface that is parallel to the main surface of each layer is referred to as a first main surface 11A. Furthermore, a surface that is parallel to the first main surface 11A is referred to as a second main surface 11B. One particular surface that is perpendicular to the first main surface 11A is referred to as a first end surface 11C. In addition, the surface that is parallel to the first end surface 11C is referred to as a second end surface 11D. Furthermore, one particular surface that is perpendicular to both the first main surface 11A and the first end surface 11C is referred to as a bottom surface 11E. In addition, the surface that is parallel to the bottom surface 11E is referred to as a top surface 11F.

Note that in the following description, an axis extending in a direction in which the plurality of layers are stacked, i.e., an axis perpendicular to the first main surface 11A is referred to as a first axis X. In addition, an axis that is perpendicular to the first end surface 11C is referred to as a second axis Y. Furthermore, an axis that is perpendicular to the bottom surface 11E is referred to as a third axis Z. Out of directions along the first axis X, the direction in which the first main surface 11A faces is referred to as a first positive direction X1 and the direction opposite to the first positive direction X1 is referred to as a first negative direction X2. Furthermore, out of directions along the second axis Y, the direction in which the first end surface 11C faces is referred to as a second positive direction Y1 and the direction opposite to the second positive direction Y1 is referred to as a second negative direction Y2. Furthermore, out of directions along the third axis Z, the direction in which the top surface 11F faces is referred to as a third positive direction Z1 and the direction opposite to the third positive direction Z1 is referred to as a third negative direction Z2.

As illustrated in FIG. 2, the element body 11 includes first to ninth layers L1 to L9. The first to ninth layers L1 to L9 are arrayed in this order in the first negative direction X2. The first to ninth layers L1 to L9 all have substantially the same thickness, i.e., the dimension in a direction along the X axis. As illustrated in FIG. 3, the first layer L1 consists of a first electrode portion 41, a second electrode portion 51, a first wiring portion 31, and a first insulating portion 21.

The first electrode portion 41 is composed of an electrically conductive material such as silver. The first electrode portion 41 is L-shaped on the whole when the first layer L1 is viewed in the first negative direction X2. The first electrode portion 41 is located on the second positive direction Y1 side and the third negative direction Z2 side relative to the center of the first layer L1 when the first layer L1 is viewed in the first negative direction X2. In other words, the first electrode portion 41 is located in a region that includes a corner on the second positive direction Y1 side and the third negative direction Z2 side relative to the center of the first layer L1 when the first layer L1 is viewed in the first negative direction X2.

The second electrode portion 51 is composed of an electrically conductive material such as silver. The second electrode portion 51 is L-shaped on the whole when the first layer L1 is viewed in the first negative direction X2. The second electrode portion 51 is located on the second negative direction Y2 side and the third negative direction Z2 side relative to the center of the first layer L1 when the first layer L1 is viewed in the first negative direction X2. In other words, the second electrode portion 51 is located in a region that includes a corner on the second negative direction Y2 side and the third negative direction Z2 side relative to the center of the first layer L1 when the first layer L1 is viewed in the first negative direction X2.

The first wiring portion 31 is composed of an electrically conductive material such as silver. The first wiring portion 31 extends in a spiral shape on the whole around the center of the first layer L1 when the first layer L1 is viewed in the first negative direction X2. Specifically, a first end portion 31A of the first wiring portion 31 is connected to an end portion of the first electrode portion 41 on the third positive direction Z1 side in a direction along the third axis Z. In other words, the first end portion 31A forms the first end of the inductor wiring 30. The wiring width of the first wiring portion 31 is substantially constant except for at a second end portion 31B thereof. The position of the second end portion 31B of the first wiring portion 31 in a direction along the third axis Z is on the third positive direction Z1 side relative to the center in a direction along the third axis Z. In addition, the position of the second end portion 31B of the first wiring portion 31 in a direction along the second axis Y is on the second positive direction Y1 side relative to the center in a direction along the second axis Y. The first wiring portion 31 extends clockwise from the first end portion 31A to the second end portion 31B when the first wiring portion 31 is viewed in the first negative direction X2.

The second end portion 31B of the first wiring portion 31 functions as a pad for connecting to a via 32, which is described later. The second end portion 31B has a substantially circular shape when the first layer L1 is viewed in the first negative direction X2. In addition, the second end portion 31B of the first wiring portion 31 has a larger wiring width than the rest of the first wiring portion 31.

The parts of the first layer L1 other than the first electrode portion 41, the second electrode portion 51, and the first wiring portion 31 are constituted by the first insulating portion 21. The first insulating portion 21 is composed of a non-magnetic material such as glass, resin, or alumina.

As illustrated in FIG. 2, the second layer L2 is stacked on a main surface of the first layer L1 that faces in the first negative direction X2. The second layer L2 has the same rectangular shape as the first layer L1 when the second layer L2 is viewed in the first negative direction X2. The second layer L2 consists of a third electrode portion 42, a fourth electrode portion 52, the via 32, and a second insulating portion 22.

The third electrode portion 42 is composed of the same material as the first electrode portion 41. The third electrode portion 42 is L-shaped and has the same dimensions as the first electrode portion 41 when the second layer L2 is viewed in the first negative direction X2. The third electrode portion 42 is located at the same position as the first electrode portion 41 when the second layer L2 is viewed in the first negative direction X2. Therefore, the third electrode portion 42 is stacked on a surface of the first electrode portion 41 that faces in the first negative direction X2.

The fourth electrode portion 52 is composed of the same material as the second electrode portion 51. The fourth electrode portion 52 is L-shaped and has the same dimensions as the second electrode portion 51 when the second layer L2 is viewed in the first negative direction X2. The fourth electrode portion 52 is located at the same position as the second electrode portion 51 when the second layer L2 is viewed in the first negative direction X2. Therefore, the fourth electrode portion 52 is stacked on a surface of the second electrode portion 51 that faces in the first negative direction X2.

The via 32 is composed of the same material as the first wiring portion 31. The via 32 has a cylindrical shape that extends in a direction along the first axis X. The via 32 is stacked on a surface of the second end portion 31B of the first wiring portion 31 that faces in the first negative direction X2. Therefore, the via 32 is electrically connected to the second end portion 31B of the first wiring portion 31. The via 32 extends in the first negative direction X2 from the second end portion 31B of the first wiring portion 31.

The parts of the second layer L2 other than the third electrode portion 42, the fourth electrode portion 52, and the via 32 are constituted by the second insulating portion 22. The second insulating portion 22 consists of a non-magnetic insulator composed of the same material as the first insulating portion 21.

The third layer L3 is stacked on a main surface of the second layer L2 that faces in the first negative direction X2. The third layer L3 has the same rectangular shape as the first layer L1 when the third layer L3 is viewed in the first negative direction X2. The third layer L3 consists of a fifth electrode portion 43, a sixth electrode portion 53, a second wiring portion 33, and a third insulating portion 23.

The fifth electrode portion 43 is composed of the same material as the first electrode portion 41. The fifth electrode portion 43 is L-shaped and has the same dimensions as the third electrode portion 42 when the third layer L3 is viewed in the first negative direction X2. The fifth electrode portion 43 is located at the same position as the third electrode portion 42 when the third layer L3 is viewed in the first negative direction X2. Therefore, the fifth electrode portion 43 is stacked on a surface of the third electrode portion 42 that faces in the first negative direction X2.

The sixth electrode portion 53 is composed of the same material as the second electrode portion 51. The sixth electrode portion 53 is L-shaped and has the same dimensions as the fourth electrode portion 52 when the third layer L3 is viewed in the first negative direction X2. The sixth electrode portion 53 is located at the same position as the fourth electrode portion 52 when the third layer L3 is viewed in the first negative direction X2. Therefore, the sixth electrode portion 53 is stacked on a surface of the fourth electrode portion 52 that faces in the first negative direction X2.

The second wiring portion 33 is composed of the same material as the first wiring portion 31. The second wiring portion 33 extends in a spiral shape around the center of the third layer L3 on the whole when the third layer L3 is viewed in the first negative direction X2. Specifically, the position of a first end portion 33A of the second wiring portion 33 lies on a surface of the via 32 that faces in the first negative direction X2. Therefore, the first end portion 33A of the second wiring portion 33 is connected to the via 32. The wiring width of the second wiring portion 33 is substantially constant except for at the first end portion 33A and a second end portion 33B thereof. The position of the second end portion 33B of the second wiring portion 33 in a direction along the third axis Z is on the third negative direction Z2 side relative to the center in a direction along the third axis Z. In addition, the position of the second end portion 33B of the second wiring portion 33 in a direction along the second axis Y is on the second positive direction Y1 side relative to the center in the direction along the second axis Y and is nearer the center in the direction along the second axis Y than the position of the second end portion 31B of the first wiring portion 31 in the direction along the second axis Y. The second wiring portion 33 extends clockwise from the first end portion 33A to the second end portion 33B when the second wiring portion 33 is viewed in the first negative direction X2.

The parts of the third layer L3 other than the fifth electrode portion 43, the sixth electrode portion 53, and the second wiring portion 33 are constituted by the third insulating portion 23. The third insulating portion 23 consists of a non-magnetic insulator composed of the same material as the first insulating portion 21.

The fourth layer L4 is stacked on a main surface of the third layer L3 that faces in the first negative direction X2. The fourth layer L4 has the same rectangular shape as the first layer L1 when the fourth layer L4 is viewed in the first negative direction X2. The fourth layer L4 consists of a seventh electrode portion 44, an eighth electrode portion 54, a via 34, and a fourth insulating portion 24.

The seventh electrode portion 44 is composed of the same material as the first electrode portion 41. The seventh electrode portion 44 is L-shaped and has the same dimensions as the fifth electrode portion 43 when the fourth layer L4 is viewed in the first negative direction X2. The seventh electrode portion 44 is located at the same position as the fifth electrode portion 43 when the fourth layer L4 is viewed in the first negative direction X2. Therefore, the seventh electrode portion 44 is stacked on a surface of the fifth electrode portion 43 that faces in the first negative direction X2.

The eighth electrode portion 54 is composed of the same material as the second electrode portion 51. The eighth electrode portion 54 is L-shaped and has the same dimensions as the sixth electrode portion 53 when the fourth layer L4 is viewed in the first negative direction X2. The eighth electrode portion 54 is located at the same position as the sixth electrode portion 53 when the fourth layer L4 is viewed in the first negative direction X2. Therefore, the eighth electrode portion 54 is stacked on a surface of the sixth electrode portion 53 that faces in the first negative direction X2.

The via 34 is composed of the same material as the first wiring portion 31. The via 34 has a cylindrical shape that extends in a direction along the first axis X. The via 34 is stacked on a surface of the second end portion 33B of the second wiring portion 33 that faces in the first negative direction X2. Therefore, the via 34 is electrically connected to the second end portion 33B of the second wiring portion 33. The via 34 extends in the first negative direction X2 from the second end portion 33B of the second wiring portion 33.

The parts of the fourth layer L4 other than the seventh electrode portion 44, the eighth electrode portion 54, and the via 34 are constituted by the fourth insulating portion 24. The fourth insulating portion 24 consists of a non-magnetic insulator composed of the same material as the first insulating portion 21.

The fifth layer L5 is stacked on a main surface of the fourth layer L4 that faces in the first negative direction X2. The fifth layer L5 has the same rectangular shape as the first layer L1 when the fifth layer L5 is viewed in the first negative direction X2. The fifth layer L5 consists of a ninth electrode portion 45, a tenth electrode portion 55, a third wiring portion 35, and a fifth insulating portion 25.

The ninth electrode portion 45 is composed of the same material as the first electrode portion 41. The ninth electrode portion 45 is L-shaped and has the same dimensions as the seventh electrode portion 44 when the fifth layer L5 is viewed in the first negative direction X2. The ninth electrode portion 45 is located at the same position as the seventh electrode portion 44 when the fifth layer L5 is viewed in the first negative direction X2. Therefore, the ninth electrode portion 45 is stacked on a surface of the seventh electrode portion 44 that faces in the first negative direction X2.

The tenth electrode portion 55 is composed of the same material as the second electrode portion 51. The tenth electrode portion 55 is L-shaped and has the same dimensions as the eighth electrode portion 54 when the fifth layer L5 is viewed in the first negative direction X2. The tenth electrode portion 55 is located at the same position as the second electrode portion 51 when the fifth layer L5 is viewed in the first negative direction X2. Therefore, the tenth electrode portion 55 is stacked on a surface of the eighth electrode portion 54 that faces in the first negative direction X2.

The third wiring portion 35 is composed of the same material as the first wiring portion 31. The third wiring portion 35 extends in a spiral shape around the center of the fifth layer L5 on the whole when the fifth layer L5 is viewed in the first negative direction X2. Specifically, the position of a first end portion 35A of the third wiring portion 35 lies on a surface of the via 34 that faces in the first negative direction X2. Therefore, the first end portion 35A of the third wiring portion 35 is connected to the via 34. The wiring width of the third wiring portion 35 is substantially constant except for at the first end portion 35A and a second end portion 35B thereof. The position of the second end portion 35B of the third wiring portion 35 in a direction along the third axis Z is on the third negative direction Z2 side relative to the center in a direction along the third axis Z. In addition, the position of the second end portion 35B of the third wiring portion 35 in a direction along the second axis Y is on the second negative direction Y2 side relative to the center in a direction along the second axis Y. The third wiring portion 35 extends clockwise from the first end portion 35A to the second end portion 35B when the third wiring portion 35 is viewed in the first negative direction X2.

The parts of the fifth layer L5 other than the ninth electrode portion 45, the tenth electrode portion 55, and the third wiring portion 35 are constituted by the fifth insulating portion 25. The fifth insulating portion 25 consists of a non-magnetic insulator composed of the same material as the first insulating portion 21.

The sixth layer L6 is stacked on a main surface of the fifth layer L5 that faces in the first negative direction X2. The sixth layer L6 has the same rectangular shape as the first layer L1 when the sixth layer L6 is viewed in the first negative direction X2. The sixth layer L6 consists of an eleventh electrode portion 46, a twelfth electrode portion 56, a via 36, and a sixth insulating portion 26.

The eleventh electrode portion 46 is composed of the same material as the first electrode portion 41. The eleventh electrode portion 46 is L-shaped and has the same dimensions as the ninth electrode portion 45 when the sixth layer L6 is viewed in the first negative direction X2. The eleventh electrode portion 46 is located at the same position as the ninth electrode portion 45 when the sixth layer L6 is viewed in the first negative direction X2. Therefore, the eleventh electrode portion 46 is stacked on a surface of the ninth electrode portion 45 that faces in the first negative direction X2.

The twelfth electrode portion 56 is composed of the same material as the second electrode portion 51. The twelfth electrode portion 56 is L-shaped and has the same dimensions as the tenth electrode portion 55 when the sixth layer L6 is viewed in the first negative direction X2. The twelfth electrode portion 56 is located at the same position as the tenth electrode portion 55 when the sixth layer L6 is viewed in the first negative direction X2. Therefore, the twelfth electrode portion 56 is stacked on a surface of the tenth electrode portion 55 that faces in the first negative direction X2.

The via 36 is composed of the same material as the first wiring portion 31. The via 36 has a cylindrical shape that extends in a direction along the first axis X. The via 36 is stacked on a surface of the second end portion 35B of the third wiring portion 35 that faces in the first negative direction X2. Therefore, the via 36 is electrically connected to the second end portion 35B of the third wiring portion 35. The via 36 extends in the first negative direction X2 from the second end portion 35B of the third wiring portion 35.

The parts of the sixth layer L6 other than the eleventh electrode portion 46, the twelfth electrode portion 56, and the via 36 are constituted by the sixth insulating portion 26. The sixth insulating portion 26 consists of a non-magnetic insulator composed of the same material as the first insulating portion 21.

The seventh layer L7 is stacked on a main surface of the sixth layer L6 that faces in the first negative direction X2. The seventh layer L7 has the same rectangular shape as the first layer L1 when the seventh layer L7 is viewed in the first negative direction X2. The seventh layer L7 consists of a thirteenth electrode portion 47, a fourteenth electrode portion 57, a fourth wiring portion 37, and a seventh insulating portion 27.

The thirteenth electrode portion 47 is composed of the same material as the first electrode portion 41. The thirteenth electrode portion 47 is L-shaped and has the same dimensions as the eleventh electrode portion 46 when the seventh layer L7 is viewed in the first negative direction X2. The thirteenth electrode portion 47 is located at the same position as the eleventh electrode portion 46 when the seventh layer L7 is viewed in the first negative direction X2. Therefore, the thirteenth electrode portion 47 is stacked on a surface of the eleventh electrode portion 46 that faces in the first negative direction X2.

The fourteenth electrode portion 57 is composed of the same material as the second electrode portion 51. The fourteenth electrode portion 57 is L-shaped and has the same dimensions as the twelfth electrode portion 56 when the seventh layer L7 is viewed in the first negative direction X2. The fourteenth electrode portion 57 is located at the same position as the twelfth electrode portion 56 when the seventh layer L7 is viewed in the first negative direction X2. Therefore, the fourteenth electrode portion 57 is stacked on a surface of the twelfth electrode portion 56 that faces in the first negative direction X2.

The fourth wiring portion 37 is composed of the same material as the first wiring portion 31. The fourth wiring portion 37 extends in a spiral shape around the center of the seventh layer L7 on the whole when the seventh layer L7 is viewed in the first negative direction X2. Specifically, the position of a first end portion 37A of the fourth wiring portion 37 lies on a surface of the via 36 that faces in the first negative direction X2. Therefore, the first end portion 37A of the fourth wiring portion 37 is connected to the via 36. The wiring width of the fourth wiring portion 37 is substantially constant except for at the first end portion 37A and a second end portion 37B thereof. The position of the second end portion 37B of the fourth wiring portion 37 in a direction along the third axis Z is on the third positive direction Z1 side relative to the center in a direction along the third axis Z. In addition, the position of the second end portion 37B of the fourth wiring portion 37 in a direction along the second axis Y is on the second negative direction Y2 side relative to the center in the direction along the second axis Y and is on the second negative direction Y2 side relative to the position of the first end portion 37A in the direction along the second axis Y. The fourth wiring portion 37 extends clockwise from the first end portion 37A to the second end portion 37B when the fourth wiring portion 37 is viewed in the first negative direction X2. In addition, the fourth wiring portion 37 has rotational symmetry with the second wiring portion 33 with the axis of rotation being an axis in a direction along the third axis Z passing through the center in the direction of extension of the inductor wiring 30.

The parts of the seventh layer L7 other than the thirteenth electrode portion 47, the fourteenth electrode portion 57, and the fourth wiring portion 37 are constituted by the seventh insulating portion 27. The seventh insulating portion 27 consists of a non-magnetic insulator composed of the same material as the first insulating portion 21.

The eighth layer L8 is stacked on a main surface of the seventh layer L7 that faces in the first negative direction X2. The eighth layer L8 has the same rectangular shape as the first layer L1 when the eighth layer L8 is viewed in the first negative direction X2. The eighth layer L8 consists of a fifteenth electrode portion 48, a sixteenth electrode portion 58, a via 38, and an eighth insulating portion 28.

The fifteenth electrode portion 48 is composed of the same material as the first electrode portion 41. The fifteenth electrode portion 48 is L-shaped and has the same dimensions as the thirteenth electrode portion 47 when the eighth layer L8 is viewed in the first negative direction X2. The fifteenth electrode portion 48 is located at the same position as the thirteenth electrode portion 47 when the eighth layer L8 is viewed in the first negative direction X2. Therefore, the fifteenth electrode portion 48 is stacked on a surface of the thirteenth electrode portion 47 that faces in the first negative direction X2.

The sixteenth electrode portion 58 is composed of the same material as the second electrode portion 51. The sixteenth electrode portion 58 is L-shaped and has the same dimensions as the fourteenth electrode portion 57 when the eighth layer L8 is viewed in the first negative direction X2. The sixteenth electrode portion 58 is located at the same position as the fourteenth electrode portion 57 when the eighth layer L8 is viewed in the first negative direction X2. Therefore, the sixteenth electrode portion 58 is stacked on a surface of the fourteenth electrode portion 57 that faces in the first negative direction X2.

The via 38 is composed of the same material as the first wiring portion 31. The via 38 has a cylindrical shape that extends in a direction along the first axis X. The via 38 is stacked on a surface of the second end portion 37B of the fourth wiring portion 37 that faces in the first negative direction X2. Therefore, the via 38 is electrically connected to the second end portion 37B of the fourth wiring portion 37. The via 38 extends in the first negative direction X2 from the second end portion 37B of the fourth wiring portion 37.

The parts of the eighth layer L8 other than the fifteenth electrode portion 48, the sixteenth electrode portion 58, and the via 38 are constituted by the eighth insulating portion 28. The eighth insulating portion 28 consists of a non-magnetic insulator composed of the same material as the first insulating portion 21.

The ninth layer L9 is stacked on a main surface of the eighth layer L8 that faces in the first negative direction X2. The ninth layer L9 has the same rectangular shape as the first layer L1 when the ninth layer L9 is viewed in the first negative direction X2. The ninth layer L9 consists of a seventeenth electrode portion 49, an eighteenth electrode portion 59, a fifth wiring portion 39, and a ninth insulating portion 29.

The seventeenth electrode portion 49 is composed of the same material as the first electrode portion 41. The seventeenth electrode portion 49 is L-shaped and has the same dimensions as the fifteenth electrode portion 48 when the ninth layer L9 is viewed in the first negative direction X2. The seventeenth electrode portion 49 is located at the same position as the fifteenth electrode portion 48 when the ninth layer L9 is viewed in the first negative direction X2. Therefore, the seventeenth electrode portion 49 is stacked on a surface of the fifteenth electrode portion 48 that faces in the first negative direction X2.

The eighteenth electrode portion 59 is composed of the same material as the second electrode portion 51. The eighteenth electrode portion 59 is L-shaped and has the same dimensions as the sixteenth electrode portion 58 when the ninth layer L9 is viewed in the first negative direction X2. The eighteenth electrode portion 59 is located at the same position as the sixteenth electrode portion 58 when the ninth layer L9 is viewed in the first negative direction X2. Therefore, the eighteenth electrode portion 59 is stacked on a surface of the sixteenth electrode portion 58 that faces in the first negative direction X2.

The fifth wiring portion 39 is composed of the same material as the first wiring portion 31. The fifth wiring portion 39 extends in a spiral shape around the center of the ninth layer L9 on the whole when the ninth layer L9 is viewed in the first negative direction X2. Specifically, the position of a first end portion 39A of the fifth wiring portion 39 lies on a surface of the via 38 that faces in the first negative direction X2. Therefore, the first end portion 39A of the fifth wiring portion 39 is connected to the via 38. The wiring width of the fifth wiring portion 39 is substantially constant except for at the first end portion 39A thereof. A second end portion 39B of the fifth wiring portion 39 is connected to an end portion of the eighteenth electrode portion 59 on the third positive direction Z1 side in a direction along the third axis Z. The fifth wiring portion 39 extends clockwise from the first end portion 39A to the second end portion 39B when the fifth wiring portion 39 is viewed in the first negative direction X2. The second end portion 39B of the fifth wiring portion 39 forms the second end of the inductor wiring 30. Furthermore, the fifth wiring portion 39 has rotational symmetry with the first wiring portion 31 with the axis of rotation being an axis in a direction along the third axis Z passing through the center in the direction of extension of the inductor wiring 30.

The parts of the ninth layer L9 other than the seventeenth electrode portion 49, the eighteenth electrode portion 59, and the fifth wiring portion 39 are constituted by the ninth insulating portion 29. The ninth insulating portion 29 consists of an insulator composed of the same material as the first insulating portion 21.

The element body 11 includes a first coating insulating layer 61 and a second coating insulating layer 62. The first coating insulating layer 61 has the same rectangular shape as the first layer L1 when the first coating insulating layer 61 is viewed in the first negative direction X2. The first coating insulating layer 61 is stacked on a main surface of the first layer L1 that faces in the first positive direction X1. The second coating insulating layer 62 has the same rectangular shape as the first layer L1 when the second coating insulating layer 62 is viewed in the first positive direction X1. The second coating insulating layer 62 is stacked on a main surface of the ninth layer L9 that faces in the first negative direction X2.

The first to ninth insulating portions 21 to 29, the first coating insulating layer 61, and the second coating insulating layer 62 described above are integrated with each other. Hereafter, when there is no need to distinguish between these components, the components are collectively referred to as an insulating portion 20.

In addition, the first wiring portion 31, the second wiring portion 33, the third wiring portion 35, the fourth wiring portion 37, the fifth wiring portion 39, the via 32, the via 34, the via 36, and the via 38 are integrated with each other. Hereafter, when there is no need to distinguish between these components, the components are collectively referred to as the inductor wiring 30. The inductor wiring 30 is wound in a spiral shape on the whole. A center axis around which the inductor wiring 30 is wound is an axis that extends along the first axis X.

In addition, the first electrode portion 41, the third electrode portion 42, the fifth electrode portion 43, the seventh electrode portion 44, the ninth electrode portion 45, the eleventh electrode portion 46, the thirteenth electrode portion 47, the fifteenth electrode portion 48, and the seventeenth electrode portion 49 described above are integrated with each other. Together these portions form the first electrode 40.

Similarly, the second electrode portion 51, the fourth electrode portion 52, the sixth electrode portion 53, the eighth electrode portion 54, the tenth electrode portion 55, the twelfth electrode portion 56, the fourteenth electrode portion 57, the sixteenth electrode portion 58, and the eighteenth electrode portion 59 described above are integrated with each other. Together these portions form the second electrode 50.

In this embodiment, the element body 11 of the inductor component 10 is formed of the insulating portion 20, the first electrode 40, and the second electrode 50. The inductor wiring 30 extends inside the element body 11. The inductor wiring 30, the first electrode 40, and the second electrode 50 may be integrated with each other. In other words, there does not have to be a physical boundary between the inductor wiring 30 and the first electrode 40.

The first to ninth layers L1 to L9, the first coating insulating layer 61, and the second coating insulating layer 62 are stacked on top of one another, and as a result, the element body 11 has a rectangular parallelepiped shape on the whole, as illustrated in FIG. 1. As illustrated in FIG. 3, the first electrode 40 is exposed to outside the element body 11 in a region spanning from the first end surface 11C to the bottom surface 11E. In addition, the second electrode 50 is exposed to outside the element body 11 in a region spanning from the second end surface 11D to the bottom surface 11E.

As illustrated in FIG. 1, the inductor component 10 includes a first coating electrode 71 and a second coating electrode 72. The first coating electrode 71 covers a surface of the first electrode 40 that is exposed to the outside from the element body 11. Although not illustrated, the first coating electrode 71 has a two-layer structure consisting of a nickel plating layer and a tin plating layer.

The second coating electrode 72 covers a surface of the second electrode 50 that is exposed to the outside from the element body 11. Although not illustrated, the second coating electrode 72 has a two-layer structure consisting of a nickel plating layer and a tin plating layer. Note that illustration of the first coating electrode 71 and the second coating electrode 72 is omitted from FIGS. 2 and 3.

Thickness of Interlayer Insulating Layers and Average Particle Size of Filler Particles

As illustrated in FIG. 4, the first wiring portion 31, the second wiring portion 33, the third wiring portion 35, the fourth wiring portion 37, and the fifth wiring portion 39 of the inductor wiring 30 are arrayed along the first axis X. In this embodiment, the first negative direction X2 is taken to be a first direction.

Parts of the insulating portion 20 form interlayer insulating layers NL. The interlayer insulating layers NL fill the spaces between the wiring portions arrayed along the first axis X. Specifically, the insulating portion 20 includes four interlayer insulating layers NL. When distinguishing between the four interlayer insulating layers NL, the interlayer insulating layers NL are referred to as first to fourth interlayer insulating layers NL1 to NL4. The part of the second insulating portion 22 in the second layer L2 filling the space between the first wiring portion 31 and the second wiring portion 33 constitutes the first interlayer insulating layer NL1 between the first wiring portion 31 and the second wiring portion 33. The part of the fourth insulating portion 24 in the fourth layer L4 filling the space between the second wiring portion 33 and the third wiring portion 35 constitutes the second interlayer insulating layer NL2 between the second wiring portion 33 and the third wiring portion 35. The part of the sixth insulating portion 26 in the sixth layer L6 filling the space between the third wiring portion 35 and the fourth wiring portion 37 constitutes the third interlayer insulating layer NL3 between the third wiring portion 35 and the fourth wiring portion 37. The part of the eighth insulating portion 28 in the eighth layer L8 filling the space between the fourth wiring portion 37 and the fifth wiring portion 39 constitutes the fourth interlayer insulating layer NL4 between the fourth wiring portion 37 and the fifth wiring portion 39. The interlayer insulating layers NL refer to only the parts of the insulating portion 20 that are interposed between adjacent wiring portions. In other words, the interlayer insulating layers NL do not include the parts that are not interposed between adjacent wiring portions.

The dimensions of the plurality of interlayer insulating layers NL in the direction along the first axis X vary due to materials, processes, and manufacturing errors. Specifically, in this embodiment, the interlayer insulating layers NL are formed by sintering a powder or multiple particles, and therefore the dimensions of the interlayer insulating layers NL vary in the direction along the first axis X. The average thickness of the first interlayer insulating layer NL1, which is the average value of the thickness of the first interlayer insulating layer NL1, is greater than five times the standard deviation of the thickness of the first interlayer insulating layer NL1. The average thickness and standard deviation of the first interlayer insulating layer NL1 are calculated as follows

First, a cross section is identified in which the first wiring portion 31, the second wiring portion 33, and the first interlayer insulating layer NL1 are stacked along the first axis X. This cross section is a cross section parallel to the first axis X. The cross section, for example, includes a location where the first wiring portion 31 and the second wiring portion 33 extend in straight lines and where the first interlayer insulating layer NL1 can be detected over a length of at least 100 μm or more. Specifically, the cross section is a cross section where the first interlayer insulating layer NL1 has its longest length. In particular, the cross-section is preferably a cross-section obtained by cutting along the center of a part where the first and second wiring portions 31 and 33 extend in a straight line.

Next, an image of the identified cross section is acquired using an electron microscope. The resolution of the acquired image is such that one pixel has a size of 0.4 μm or less. Next, the acquired image is subjected to binarization. Then the binarized data is converted into a bitmap format.

Next, from the bitmap format image, the numerical values of the thickness of the first interlayer insulating layer NL1 are acquired for columns of pixels along the first axis X on a column-by-column basis in a central portion of the first interlayer insulating layer NL1 having a length of 100 the length being in a direction perpendicular to the first axis X. For example, if one pixel has a size of 0.4 μm, the numerical values of the thickness of the first interlayer insulating layer NL1 are acquired in 250 columns. The arithmetic mean of these 250 values is calculated as the average thickness. The standard deviation obtained assuming that these 250 numerical values are normally distributed is also calculated. The average thickness and the standard deviation are calculated in the same way for the second interlayer insulating layer NL2, the third interlayer insulating layer NL3, and the fourth interlayer insulating layer NL4. In this embodiment, the average thicknesses of all the interlayer insulating layers NL are greater than or equal to 5.0 μm. The standard deviations of all the interlayer insulating layers NL are smaller than 1.0 μm.

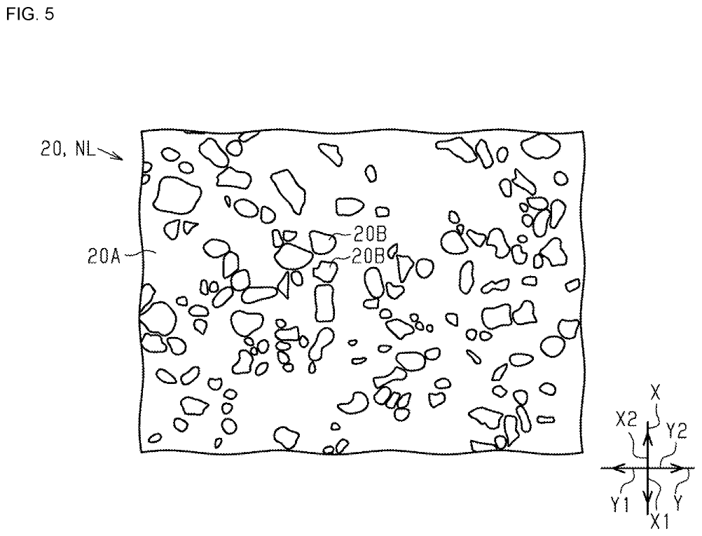

As illustrated in FIG. 5, the insulating portion 20 includes a base material 20A and a plurality of filler particles 20B. The base material 20A is an insulating material. Specifically, the material constituting the base material 20A is borosilicate glass.

The filler particles 20B constitute a powder of a crystalline material dispersed in the base material 20A and contains two types of filler particles, first filler particles and second filler particles of different materials. In the filler particles 20B, the material of the first filler particles is aluminum oxide and the material of the second filler particles is silicon dioxide. In the first interlayer insulating layer NL1, the average particle size of the filler particles 20B is less than or equal to the standard deviation of the thickness of the first interlayer insulating layer NL1. In the first interlayer insulating layer NL1, the average thickness of the first interlayer insulating layer NL1 is greater than five times the average particle size of the filler particles 20B. In this embodiment, the same relationship also holds true for the second interlayer insulating layer NL2, the third interlayer insulating layer NL3, and the fourth interlayer insulating layer NL4. The average particle size of the filler particles 20B in all the interlayer insulating layers NL is less than or equal to the standard deviation of the thickness of all the interlayer insulating layers NL. The average particle size of the filler particles 20B in all the plurality of interlayer insulating layers NL is calculated as the average value of the average particle sizes of the filler particles 20B in the individual interlayer insulating layers NL. The standard deviation of the thicknesses of all of the plurality of interlayer insulating layers NL is calculated as the average value of the standard deviations of the thicknesses of the interlayer insulating layers NL.

The average particle size of the filler particles 20B is calculated as follows. First, an image with a magnification of 5000× is captured using an electron microscope for a cross section for which the average thickness and standard deviation of each interlayer insulating layer NL described above are to be calculated. Next, a random number of filler particles 20B of not less than 20 and not more than 30 (i.e., from 20 to 30) are extracted from the captured image. Next, the maximum length of each extracted filler particle 20B is measured. The arithmetic mean of the measured maximum lengths is then used as the average particle size of the filler particles 20B. The maximum length of each filler particle 20B is the length of the largest line segment that can be drawn from an outer edge to an outer edge of the filler particle 20B.

Thickness of Wiring Portions and Average Grain Size of Crystallites

As illustrated in FIG. 4, the wiring thickness, which is the dimension in the direction along the first axis X, of the first wiring portion 31 varies in line with variations in the first interlayer insulating layer NL1. The average value of the wring thickness of the first wiring portion 31 is greater than five times the standard deviation of the wiring thickness of the first wiring portion 31. The average value and standard deviation of the wiring thickness of the first wiring portion 31 is calculated in substantially the same way as the average thickness and standard deviation of the first interlayer insulating layer NL1. Furthermore, the average thickness and standard deviation are calculated in substantially the same way for the second wiring portion 33, the third wiring portion 35, the fourth wiring portion 37, and the fifth wiring portion 39. In this embodiment, the average value of the wiring thickness of each wiring portion is 5.0 μm or more in each case. The standard deviation of wiring thickness of each wiring portion is smaller than 1.0 μm.

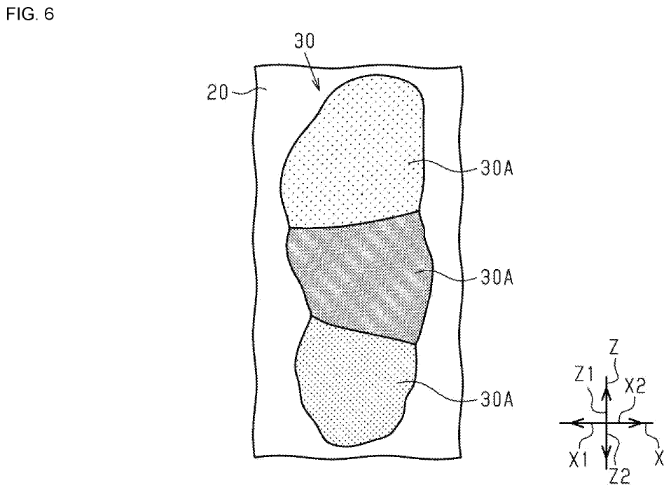

As illustrated in FIG. 6, the inductor wiring 30 is a metal sintered body obtained by sintering a powder composed of a metal. Therefore, microscopically, the inductor wiring 30 is a polycrystalline body consisting of multiple crystallites 30A formed as a result of the powder being sintered. In the first wiring portion 31, the average grain size of the crystallites 30A is larger than the standard deviation of the wiring thickness of the first wiring portion 31. Specifically, the average grain size of the crystallites 30A is greater than or equal to 2.5 μm and less than or equal to 4.1 μm (i.e., from 2.5 μm to 4.1 μm). The average value of the wiring thickness of the first wiring portion 31 is preferably larger than five times the average grain size of the crystallites 30A. In this embodiment, the same relationship exists between the average grain size of the crystallites 30A and the standard deviation of the wiring thickness of each wiring portion for the second wiring portion 33, the third wiring portion 35, the fourth wiring portion 37, and the fifth wiring portion 39. Therefore, the average grain size of crystallites 30A in all the plurality of wiring portions is less than or equal to the standard deviation of the wiring thickness in all the plurality of wiring portions. The average grain size of the crystallites 30A in all the wiring portions is calculated as the average value of the average grain sizes of the crystallites 30A in the individual wiring portions. The standard deviation of the wiring thickness in all of the plurality of wiring portions is calculated as the average value of the standard deviations of the wiring thicknesses in the wiring portions.

The average grain size of the crystallites 30A is calculated as follows. First, five cross sections of the inductor wiring 30 in a direction perpendicular to the direction of extension of the wiring portions are identified. Out of the five cross sections, the regions including the first wiring portion 31 are observed using an electron microscope. The electron microscope radiates electron beams to these regions and detects reflected electrons generated in the regions. Reflected electrons can be observed using different contrasts for each crystallographic orientation of the crystallites 30A. In other words, by observing the reflected electrons, grain boundaries between adjacent crystallites 30A can be identified. Next, the area of one crystallite 30A is calculated based on the grain boundaries identified in the same cross section. Next, assuming that the area of the one crystallite 30A is a circle, the diameter of one crystallite 30A is calculated as the grain size of the crystallite 30A. The grain sizes of all the crystallites 30A in the same cross section are then calculated. The grain sizes of all the crystallites 30A in the other cross sections are similarly calculated. Next, the average value of the grain sizes of all the crystallites 30A measured in the five cross sections is calculated as the average grain size of the crystallites 30A in the first wiring portion 31. In this embodiment, the average grain size of the crystallites 30A is greater than or equal to 2.5 μm and less than or equal to 4.1 μm (i.e., from 2.5 μm to 4.1 μm).

### Effects of Embodiment

The above embodiment exhibits the following effects.

(1) According to the above embodiment, in the first interlayer insulating layer NL1, the average particle size of the filler particles 20B is smaller than the standard deviation of the thickness of the first interlayer insulating layer NL1. Therefore, the average particle size of filler particles 20B is unlikely to have a significant effect on the standard deviation of the thickness of the first interlayer insulating layer NL1. Therefore, it is possible to prevent variations in the thickness of the first interlayer insulating layer NL1 from becoming large due to the average particle size of the filler particles 20B.

Let us suppose that the average particle size of the filler particles 20B is larger than the standard deviation of the first interlayer insulating layer NL1. In this case, the standard deviation of the thickness of the first interlayer insulating layer NL1 is correspondingly large. Projecting portions protruding toward the adjacent first wiring portion 31 and second wiring portion 33 are sharp. If the protrusions are sharp, when a current is applied to the inductor wiring 30, the current will be concentrated at the tips of the protrusions. Therefore, current loss will be large. On the other hand, according to the above embodiment, since variations in the thickness of the first interlayer insulating layer NL1 can be prevented from becoming large due to the average particle size of the filler particles 20B, such protrusions are smoother. Therefore, when a current is applied to the inductor wiring 30, the current is distributed not only to the tips of the protrusions, but also to the regions around the tips of the protrusions. As a result, current loss is reduced compared to when the projections are sharp.

(2) According to the above embodiment, the standard deviation of the thickness of the first interlayer insulating layer NL1 is smaller than 1.0 μm. In this case, the standard deviation of the thickness of the first interlayer insulating layer NL1 is sufficiently small that loss can be suppressed even if a Sub-6 class high-frequency current is applied to the inductor wiring 30.

(3) According to the above embodiment, the average thickness of the first interlayer insulating layer NL1, which is the average value of the thickness of the first interlayer insulating layer NL1, is greater than five times the standard deviation of the thickness of the first interlayer insulating layer NL1. In other words, the thickness of the first interlayer insulating layer NL1 on the whole is considerably larger than the standard deviation. Therefore, a sufficient thickness can be secured in the interlayer insulating layers NL even in locations where the thickness is smallest. Therefore, a situation can be avoided in which short circuits occur between the plurality of wiring portions at places where the thickness of the interlayer insulating layers NL is small.

(4) According to the above embodiment, the average thickness of the first interlayer insulating layer NL1 is larger than five times the average particle size of the filler particles 20B. In other words, the average particle size of filler particles 20B is smaller than one fifth the average thickness of the first interlayer insulating layer NL1. Therefore, in the first interlayer insulating layer NL1, a plurality of filler particles 20B are arrayed in a direction along the first axis X, and the filler particles 20B and the base material 20A are disposed in an alternating manner. Since the filler particles 20B are easily evenly dispersed in the first interlayer insulating layer NL1 in a direction along the first axis X, properties such as an insulating property in the first interlayer insulating layer NL1 are easily stabilized.

(5) According to the above embodiment, in all of the interlayer insulating layers NL, the average particle size of the filler particles 20B is less than or equal to the standard deviation of the thickness of all the interlayer insulating layers NL. Therefore, variations in thickness can be suppressed in all the interlayer insulating layers NL.

(6) According to the above embodiment, in the first wiring portion 31, the average grain size of the crystallites 30A is large relative to the standard deviation of the wiring thickness of the first wiring portion 31. Therefore, the shape of the outer surfaces of the crystallites 30A tends to be dominant with respect to variations in the wiring thickness of the first wiring portion 31. Therefore, variations in the thickness of the wiring portion due to the average grain size of the crystallites 30A can be suppressed.

(7) According to the above embodiment, the standard deviation of the wiring thickness of the first wiring portion 31 is smaller than 1.0 μm. In this case, the standard deviation of the wiring thickness of the first wiring portion 31 is sufficiently small that loss can be suppressed even if a Sub6 class high frequency current is applied to the inductor wiring 30.

(8) According to the above embodiment, the average value of the wring thickness of the first wiring portion 31 is greater than five times the standard deviation of the wiring thickness of the first wiring portion 31. In other words, the wiring thickness of the first wiring portion 31 as a whole is considerably larger than the standard deviation. Therefore, sufficient thickness can be secured even in locations where the wiring thickness of the first wiring portion 31 is the smallest. Therefore, a situation in which the first wiring portion 31 breaks can be avoided.

(9) According to the above embodiment, the average grain size of the crystallites 30A in all the wiring portions is larger than the standard deviation of the wiring thickness in all the wiring portions. Therefore, variations in the wiring thickness of all the wiring portions can be suppressed.

(10) According to the above embodiment, the filler particles 20B consist of a crystalline material and include first filler particles composed of an aluminum oxide material and second filler particles composed of a silicon dioxide material. Aluminum oxide has relatively high strength. As a result, it is easier to ensure the strength of the insulating portion 20. In addition, aluminum oxide has high chemical stability such as heat resistance. Therefore, the inductor component 10 can readily withstand aging when used for a long period of time. However, since aluminum oxide has a relatively large dielectric constant, if aluminum oxide is included in an excessive amount, the dielectric constant of the element body 11 on the whole will become excessively large. Therefore, the dielectric constant of the element body 11 on the whole can be prevented from becoming excessively large by simultaneously including crystalline second filler particles composed of silicon dioxide, which has a lower dielectric constant than aluminum oxide.

(11) According to the above embodiment, the material of the inductor wiring 30 contains silver, and the material of the base material 20A of the insulating portion 20 contains borosilicate glass. In order to co-sinter the inductor wiring 30 containing silver and the insulating portion 20, it is necessary to perform the sintering at a low temperature of 900° C. or lower. Borosilicate glass can be sintered at lower temperatures than silicate glass, for example. Therefore, co-sintering of the inductor wiring 30 containing silver and the insulating portion 20 can be achieved.

### Other Embodiments

The above-described embodiment can be modified in the following ways. The embodiment and the following modifications can be combined with each other to the extent that no technical inconsistencies arise.

The thicknesses of the first to ninth layers L1 to L9, i.e., the dimensions along the first axis X, do not all have to be the same. All of the layers may have different thicknesses or the thicknesses of some of the layers may be different from the thickness of other layers.

The element body 11 may have a rectangular parallelepiped shape that is long in a direction along the first axis X or may have a rectangular parallelepiped shape that is long in a direction along the third axis Z. Furthermore, the element body 11 may have a rectangular parallelepiped shape having identical dimensions in directions along the first axis X, the second axis Y, and the third axis Z. For example, with respect to the dimensions in directions along the axes of the element body 11, the dimension in a direction along the first axis X may be equal to the dimension in a direction along the third axis Z and the dimension in a direction along the second axis Y may be larger than the dimension along the first axis X. In addition, for example, with respect to the dimensions in directions along the axes of the element body 11, the dimension in a direction along the second axis Y may be larger than the dimension in a direction along the third axis Z and the dimension in a direction along the third axis Z may be larger than the dimension along the first axis X. Furthermore, for example, the dimension in a direction along the second axis Y may be larger than the dimension in a direction along the first axis X and the dimension in a direction along the first axis X may be larger than the dimension in a direction along the third axis Z.

The materials constituting the insulating portion 20 do not all have to be the same. It is sufficient that the material of the parts constituting the interlayer insulating layers NL include the base material 20A and the filler particles 20B. Therefore, for example, the first insulating layer 61 and the second insulating layer 62 may be composed of different insulating materials from the first to ninth insulating portions 21 to 29.

The base material 20A may contain other insulating materials in addition to borosilicate glass, or may be an insulating material other than borosilicate glass. For example, the base material 20A may be silicate glass. The base material 20A is preferably a sintered material. In this case, the strength and chemical stability of the element body 11, particularly the interlayer insulating layers NL, can be improved. Furthermore, in this case, the precision with which the inductor component 10 is formed can also be improved.

The material of the filler particles 20B may include other materials in addition to aluminum oxide and silicon dioxide. The material of the filler particles 20B does not have to include aluminum oxide or silicon dioxide. It is sufficient that the filler particles 20B be composed of a different material from the base material 20A. For example, if the base material 20A is an amorphous material, the filler particles 20B may be composed of a crystalline material. The filler particles 20B do not necessarily need to be composed of a crystalline material, but there need to be boundaries between the filler particles 20B and the base material 20A without the filler particles 20B integrating with the base material 20A.

It is sufficient that the average particle size of the filler particles 20B be less than or equal to the standard deviation of the thickness of the first interlayer insulating layer NL1. The average particle size of filler particles 20B is preferably greater than or equal to 0.4 μm and less than or equal to 1.4 μm (i.e., from 0.4 μm to 1.4 μm). In this case, even if the standard deviation of the thickness of the first interlayer insulating layer NL1 is quite small, the effect of the average particle size of the filler particles 20B on the standard deviation of the thickness of the first interlayer insulating layer NL1 can be kept within a certain range for practical use. For example, the average particle size of the filler particles 20B may be at least one fifth the average value of the thickness of the first interlayer insulating layer NL1.

The standard deviation of the wiring thickness of the first interlayer insulating layer NL1 may be greater than or equal to 1.0 μm. Even in this case, if the average particle size of the filler particles 20B is less than or equal to the standard deviation of the thickness of the first interlayer insulating layer NL1, the effect of the average particle size of the filler particles 20B on variations in the thickness of the first interlayer insulating layer NL1 can be reduced.

The average value of the thickness of the first interlayer insulating layer NL1 may be less than or equal to five times the standard deviation of the thickness of the first interlayer insulating layer NL1. For example, provided that the standard deviation of the thickness of the first interlayer insulating layer NL1 is reasonably small, even if the average value of the thickness of the first interlayer insulating layer NL1 is small, a situation in which multiple wiring portions become electrically connected to each other via the first interlayer insulating layer NL1 can be avoided.

The average grain size of the crystallites 30A is not limited to the example given in the above embodiment. For example, the average grain size of the crystallites 30A may be smaller than 2.5 μm or larger than 4.1 μm.

The average grain size of the crystallites 30A is preferably smaller than one fifth of the average value of the wiring thickness of the first wiring portion 31. In other words, the average value of the wiring thickness of the first wiring portion 31 is preferably larger than five times the average grain size of the crystallites 30A. In this case, the wiring thickness of the wiring portion is considerably larger than the average grain size of the crystallites 30A. Therefore, a situation in which the wiring portion breaks can be avoided.

The standard deviation of the wiring thickness of the first wiring portion 31 may be greater than or equal to 1.0 μm. Even in this case, provided that the average grain size of crystallites 30A is less than or equal to the standard deviation of the wiring thickness of the first wiring portion 31, the effect of the average grain size of the crystallites 30A on variations in the wiring thickness of the first wiring portion 31 can be reduced.

The average value of the wring thickness of the first wiring portion 31 may be less than or equal to five times the standard deviation of the wiring thickness of the first wiring portion 31. For example, provided that variations in the wiring thickness of the first wiring portion 31 are reasonably small, even if the average value of the wiring thickness of the wiring portion is small, a situation in which the wiring portion breaks can be avoided.

The average grain size of the crystallites 30A may be less than or equal to the standard deviation of the wiring thickness of the first wiring portion 31.

The inductor wiring 30 does not have to be a sintered body composed of the crystallites 30A. For example, a wire composed of a metal may be wound. In this case, the wire may be composed of a single crystal.

The shape of the first electrode 40 is not limited to the example given in the above embodiment. For example, the first electrode 40 may be connected to the first end of the inductor wiring 30 and may be at least partially exposed to the outside from the element body 11. For example, the first electrode 40 may be omitted and the first end of the inductor wiring 30 may be directly connected to the first coating electrode 71. This is also the case for the second electrode 50.

The structure of the first coating electrode 71 is not limited to the example given in the above embodiment. For example, the first coating electrode 71 may solely consist of tin plating. The first coating electrode 71 can be omitted. In this case, for example, the first electrode 40 may be fixed to a substrate or the like by soldering. This is also the case for the second coating electrode 72.

Next, technical concepts that can be grasped from the above embodiment and modifications will be described.

<1> An inductor component comprising an element body having a planar main surface among outer surfaces thereof; and an inductor wiring that extends inside the element body. The inductor wiring includes a plurality of wiring portions arrayed in a first direction perpendicular to the main surface and a via connecting the wiring portions that are adjacent to each other in the first direction. The element body includes a plurality of interlayer insulating layers that fill spaces between the wiring portions that are adjacent to each other in the first direction. The interlayer insulating layers each contain an insulating base material and a plurality of filler particles dispersed within the base material. Also, in a first interlayer insulating layer, which is one of the plurality of interlayer insulating layers, an average particle size of the filler particles is less than or equal to a standard deviation of a thickness of the first interlayer insulating layer.

<2> The inductor component according to <1>, wherein the average particle size of the filler particles is greater than or equal to 0.4 μm and less than or equal to 1.4 μm (i.e., from 0.4 μm to 1.4 μm).

<3> The inductor component according to <1> or <2>, wherein the standard deviation of the thickness of the first interlayer insulating layer is less than 1.0 μm.

<4> The inductor component according to any one of <1> to <3>, wherein an average value of the thickness of the first interlayer insulating layer is greater than five times the standard deviation of the thickness of the first interlayer insulating layer.

<5> The inductor component according to any one of <1> to <4>, wherein an average value of the thickness of the first interlayer insulating layer is greater than five times the average particle size of the filler particles.

<6> The inductor component according to any one of <1> to <5>, wherein the average particle size of the filler particles in all of the plurality of interlayer insulating layers is less than or equal to a standard deviation of a thickness of the interlayer insulating layer in all of the plurality of interlayer insulating layers.

<7> The inductor component according to any one of <1> to <6>, wherein the inductor wiring is a sintered body containing crystallites composed of a metal. Also, when a dimension of the wiring portions in the first direction is a wiring thickness, an average grain size of the crystallites is greater than a standard deviation of the wiring thickness in a first wiring portion, which is one of the plurality of wiring portions.

<8> The inductor component according to <7>, wherein the average grain size of the crystallites is greater than or equal to 2.5 μm and less than or equal to 4.1 μm (i.e., from 2.5 μm to 4.1 μm).

<9> The inductor component according to <7> or <8>, wherein the standard deviation of the wiring thickness of the first wiring portion is less than 1.0 μm.

<10> The inductor component according to any one of <7> to <9>, wherein an average value of the wiring thickness of the first wiring portion is greater than five times a standard deviation of the wiring thickness of the first wiring portion.

<11> The inductor component according to any one of <7> to <10>, wherein an average value of the wiring thickness of the first wiring portion is greater than five times an average grain size of the crystallites of the first wiring portion.

<12> The inductor component according to any one of <7> to <11>, wherein the average grain size of the crystallites in all of the plurality of wiring portions is greater than a standard deviation of the wiring thickness in all of the plurality of wiring portions.

<13> The inductor component according to any one of <1> to <12>, wherein the base material is a sintered material.

<14> The inductor component according to any one of <1> to <13>, wherein the filler particles are composed of a crystalline material and include first filler particles composed of an aluminum oxide material and second filler particles composed of a silicon dioxide material.

<15> The inductor component according to any one of <1> to <14>, wherein a material of the wiring portions contains silver, and the base material contains borosilicate glass.

What is claimed is:

1. An inductor component comprising:
an element body having a planar main surface among outer surfaces thereof; and
an inductor wiring that extends inside the element body,
wherein
the inductor wiring includes a plurality of wiring portions configured in a first direction perpendicular to the main surface and a via connecting the wiring portions that are adjacent to each other in the first direction,
the element body includes a plurality of interlayer insulating layers that fill spaces between the wiring portions that are adjacent to each other in the first direction,
the interlayer insulating layers each include an insulating base material and a plurality of filler particles dispersed within the base material, and
in a first interlayer insulating layer, which is one of the plurality of interlayer insulating layers, an average particle size of the filler particles is less than or equal to a standard deviation of a thickness of the first interlayer insulating layer.

2. The inductor component according to claim 1, wherein
the average particle size of the filler particles is from 0.4 μm to 1.4 μm.

3. The inductor component according to claim 1, wherein
the standard deviation of the thickness of the first interlayer insulating layer is less than 1.0 μm.

4. The inductor component according to claim 1, wherein
an average value of the thickness of the first interlayer insulating layer is greater than five times the standard deviation of the thickness of the first interlayer insulating layer.

5. The inductor component according to claim 1, wherein
an average value of the thickness of the first interlayer insulating layer is greater than five times the average particle size of the filler particles.

6. The inductor component according to claim 1, wherein
the average particle size of the filler particles in all of the plurality of interlayer insulating layers is less than or equal to a standard deviation of a thickness of the interlayer insulating layer in all of the plurality of interlayer insulating layers.

7. The inductor component according to claim 1, wherein
the inductor wiring is a sintered body including crystallites including a metal,
a dimension of the wiring portions in the first direction is a wiring thickness, and
an average grain size of the crystallites is greater than a standard deviation of the wiring thickness in a first wiring portion, which is one of the plurality of wiring portions.

8. The inductor component according to claim 7, wherein
the average grain size of the crystallites is from 2.5 μm to 4.1 μm.

9. The inductor component according to claim 7, wherein
the standard deviation of the wiring thickness of the first wiring portion is less than 1.0 μm.

10. The inductor component according to claim 7, wherein
an average value of the wiring thickness of the first wiring portion is greater than five times a standard deviation of the wiring thickness of the first wiring portion.

11. The inductor component according to claim 7, wherein
an average value of the wiring thickness of the first wiring portion is greater than five times an average grain size of the crystallites of the first wiring portion.

12. The inductor component according to claim 7, wherein
the average grain size of the crystallites in all the plurality of wiring portions is greater than a standard deviation of the wiring thickness in all the plurality of wiring portions.

13. The inductor component according to claim 1, wherein
the base material is a sintered material.

14. The inductor component according to claim 1, wherein
the filler particles comprise a crystalline material and include first filler particles including an aluminum oxide material and second filler particles including a silicon dioxide material.

15. The inductor component according to claim 1, wherein
a material of the wiring portions includes silver, and
the base material includes borosilicate glass.
